(19) United States
(12) Patent Application Publication
(10) Pub. No.: US 2024/0365423 A1
(43) Pub. Date: Oct. 31, 2024

(54) METHOD AND APPARATUS FOR SMALL DATA TRANSMISSION

(71) Applicant: LENOVO (BEIJING) LIMITED, Beijing (CN)

(72) Inventors: Mingzeng Dai, Shanghai (CN); Jie Shi, Beijing (CN); Ran Yue, Beijing (CN); Haiyan Luo, Shanghai (CN); Lianhai Wu, Beijing (CN); Jing Han, Beijing (CN)

(21) Appl. No.: 18/688,517

(22) PCT Filed: Sep. 3, 2021
(86) PCT No.: PCT/CN2021/116452

§ 371 Date: Mar. 1, 2024

(51) Int. Cl. H04W 76/27

(52) U.S. Cl. CPC H04W 76/27

(57) ABSTRACT

Embodiments of the present application relate to methods and apparatuses for small data transmission. An exemplary method for small data transmission (SDT) may include: transmitting an indication associated with SDT scheme selection for a user equipment (UE) from a central unit (CU) to a distributed unit (DU); receiving, by the CU from the DU, first configured granted (CG)-SDT resource configuration for the UE in the case that CG-SDT is configured; and transmitting, by the CU to the DU, a radio resource control (RRC) release message for causing the UE to enter into a non-connected state with the CG-SDT resource configuration.

### TECHNICAL FIELD

Embodiments of the present application generally relate to wireless communication technology, especially to a method and apparatus for small data transmission (SDT).

### BACKGROUND

In 3GPP (3rd generation partnership project) 5G system, small data transmission is introduced for several application scenarios. For example, according to an agreement of 3GPP TSG RAN Meeting #86, a small data transmission can be used for smartphone applications including traffic from instant messaging services or used for non-smartphone applications including traffic from wearables. A small data transmission may also be named as a small data packet or the like. Generally, any device that has intermittent small data transmissions in a non-connected state, e.g., a radio resource control (RRC) inactive state or a RRC idle state will benefit from enabling small data transmission in the non-connected state.

According to a new radio (NR) Rel-17 work item, there are two schemes for small data transmission in RRC_INACTIVE state as follows:
Uplink (UL) small data transmissions using random access channel (RACH)-based schemes (e.g. using 2-step RACH and 4-step RACH), which is named as random access (RA)-SDT or RA-based SDT or RACH-based SDT.
UL small data transmissions on pre-configured physical uplink shared channel (PUSCH) resource(s) (e.g. reusing configured grant (CG) type 1 PUSCH resources), which is named as CG-SDT or CG-based SDT.

However, several issues on CG-SDT have not been discussed yet. For example, considering a central unit (CU)-distributed unit (DU) split based radio access network (RAN) architecture, which one of the CU and DU is responsible for selecting (or determining) the SDT scheme to be configured for user equipment (UE) and how; in the case that UE falls back to from CG-SDT to RA-SDT or non-SDT, how the CU and DU reconfigure the previous (or old) CG-SDT resource configuration information in a new UE associated logical F1 connection; and when a time alignment timer (TAT)-SDT expires, how to release the UE context, the UE associated logical F1 connection and use plane resource between the CU and DU.

Given the above, the industry desires improved technology for small data transmission, especially for CG-SDT.

### SUMMARY OF THE APPLICATION

One objective of the embodiments of the present application is to provide a technical solution for small data transmission, e.g., technical solutions for CG-SDT configuration, reconfiguration and release over F1 interface etc.

According to some embodiments of the present application, a method for SDT includes: transmitting an indication associated with SDT scheme selection for a UE from a CU to a DU; receiving, by the CU from the DU, first CG-SDT resource configuration information for the UE in the case that CG-SDT is configured; and transmitting, by the CU to the DU, a RRC release message for causing the UE to enter into a non-connected state with the first CG-SDT resource configuration information.

In some embodiments of the present application, the indication associated with SDT scheme selection is a CG-SDT required indication or a CG-SDT inquiry indication in the case that the CU determines that CG-SDT is to be configured for the UE. The CG-SDT required indication or the CG-SDT inquiry indication is associated with a data radio bearer (DRB).

In some embodiments of the present application, the indication associated with SDT scheme selection is an SDT indication indicating the DU whether a DRB or a quality of service (QOS) flow or a protocol data unit (PDU) session is subject to an SDT.

In some embodiments of the present application, the method may include storing, by the CU, the first CG-SDT resource configuration information received from the DU. The method may further include: receiving, by the CU from the DU, an indication of RA-SDT which indicates that RA-SDT is performed by the UE which has entered into the non-connected state caused by the RRC release message; and transmitting, by the CU to the DU, the first CG-SDT resource configuration information so that CG-SDT resource configuration information is to be reconfigured for the UE based on the first CG-SDT resource configuration information after the RA-SDT. The first CG-SDT resource configuration information is a RRC container transmitted in a CU to DU RRC container information element (IE), or is transmitted in a UE context modification request message.

In some embodiments of the present application, the method may include: receiving, by the CU from the DU, an indication of RA-SDT which indicates that RA-SDT is performed by the UE which has entered into the non-connected state caused by the RRC release message; and transmitting, by the CU to the DU, an identity (ID) of the first CG-SDT resource configuration information so that CG-SDT resource configuration information is to be reconfigured for the UE based on the first CG-SDT resource configuration information after the RA-SDT. The identity of the first CG-SDT resource configuration information is a cell-radio network temporary identifier (C-RNTI) associated with the UE or a DU UE F1 application protocol (F1AP) identity associated with the UE, wherein the DU UE F1AP identity is used to uniquely identify a previous UE associated F1 connection for the UE within the DU. The identity of the first CG-SDT resource configuration information is transmitted in a UE context modification request message.

In some embodiments of the present application, the method may include: receiving, by the CU from the DU, second CG-SDT resource configuration information for replacing the first CG-SDT resource configuration information; and transmitting, by the CU to the DU, another RRC release message for the UE with the second CG-SDT resource configuration information. The method may further include: storing the second CG-SDT resource configuration information by the CU. The second CG-SDT resource configuration information is full CG-SDT resource configuration information in some embodiments of the present application.

In some embodiments of the present application, the method may include: transmitting, by the CU to the DU, radio link measurement information for CG-SDT resource selection.

The method may further include: receiving, by the CU from the DU, a TAT-SDT; starting, by the CU, the TAT-SDT in response to triggering a UE context release procedure; and stopping, by the CU, the TAT-SDT in response to receiving small data or receiving a resume request message. The method may further include: releasing, by the CU, logic F1 connection associated with the UE and related UE context in response to expiry of the TAT-SDT.

In some embodiments of the present application, the method may include: receiving, by the CU from the DU, a UE context release request message for requesting the CU to release logic F1 connection associated with the UE, wherein the UE context release request message includes a cause value indicating that the UE context release request message is caused by the expiry of a TAT-SDT.

According to some embodiments of the present application, a method for SDT includes: receiving an indication associated with SDT scheme selection for a UE from a CU by a DU; transmitting, by the DU to the CU, first CG-SDT resource configuration information for the UE in the case that CG-SDT is configured; and receiving, by the DU from the CU, a RRC release message for causing the UE to enter into a non-connected state with the first CG-SDT resource configuration information.

In some embodiments of the present application, the indication associated with SDT scheme selection is a CG-SDT required indication or a CG-SDT inquiry indication indicating the DU that CG-SDT is required or requested to be configured for the UE. The CG-SDT required indication or the CG-SDT inquiry indication is associated with a DRB.

In some embodiments of the present application, the indication associated with SDT scheme selection is an SDT indication indicating the DU whether a DRB or a QoS flow or a PDU session is subject to an SDT, and the method further includes:

determining whether CG-SDT is to be configured by the DU. The method may further include: storing, by the DU, the first CG-SDT resource configuration information and C-RNTI associated with the UE in response to receiving a UE context release message from the CU. The first CG-SDT resource configuration information is preconfigured in the DU. The method may also include: applying, by the DU, the first CG-SDT resource configuration information in the case of releasing the UE to the non-connected state.

In some embodiments of the present application, transmitting, by the DU to the CU, an indication of RA-SDT which indicates that RA-SDT is performed by the UE which has entered into the non-connected state caused by the RRC release message; and receiving, by the DU from the CU, the first CG-SDT resource configuration information so that CG-SDT resource configuration information is to be reconfigured for the UE based on the first CG-SDT resource configuration information after the RA-SDT.

In some embodiments of the present application, the method may include: transmitting, by the DU to the CU, an indication of RA-SDT which indicates that RA-SDT is performed by the UE which has entered into the non-connected state caused by the RRC release message; and receiving, by the DU from the CU, an identity of the first CG-SDT resource configuration information so that CG-SDT resource configuration information is to be reconfigured for the UE based on the first CG-SDT resource configuration information after the RA-SDT.

In some embodiments of the present application, the method may include: transmitting, by the DU to the CU, second CG-SDT resource configuration information for replacing the first CG-SDT resource configuration information; and receiving, by the DU from the CU, another RRC release message for the UE with the second CG-SDT resource configuration information. The method may further include: transmitting, by the DU to the UE, a network indication indicating releasing the first CG-SDT resource configuration information. The network indication indicates releasing the first CG-SDT resource configuration information by including the second CG-SDT resource configuration information as full CG-SDT resource configuration information in the other RRC release message.

In some embodiments of the present application, the method may include: receiving, by the DU from the CU, radio link measurement information for CG-SDT resource selection.

In some embodiments of the present application, the method may include: transmitting a TAT-SDT to the CU by the DU; and transmitting a remaining value of the TAT-SDT to the CU by the DU in the case that the TAT-SDT has been started in response to releasing the UE into the non-connected state.

In some embodiments of the present application, the method may include: transmitting a TAT-SDT to the CU by the DU; and starting the TAT-SDT by the DU in response to the TAT-SDT being configured or transmitting the RRC release message to the UE.

In some embodiments of the present application, the method may include: releasing, by the DU, logic F1 connection associated with the UE and related UE context in response to expiry of the TAT-SDT.

In some embodiments of the present application, the method may include: transmitting, by the DU to the CU, a UE context release request message for requesting the CU to release logic F1 connection associated with the UE, wherein the UE context release request message includes a cause value indicating that the UE context release request message is caused by expiry of the TAT-SDT.

According to some embodiments of the present application, a method for SDT includes: receiving, by a UE from a network side, a RRC release message with first CG-SDT resource configuration information; entering into a non-connected state in response to receiving the RRC release message; and releasing, by the UE, the first CG-SDT resource configuration information in response to one of the following: receiving another RRC release message; falling back to RA-SDT or non-SDT from CG-SDT; receiving a network indication indicating releasing the first CG-SDT resource configuration information; and expiry of a TAT-SDT associated with the first CG-SDT resource configuration information.

In some embodiments of the present application, the method may include: releasing the first CG-SDT resource configuration information and applying second CG-SDT resource configuration information if any in response to receiving the RRC release message.

In some embodiments of the present application, the network indication indicates releasing the first CG-SDT resource configuration information by including full CG-SDT resource configuration information in the other RRC release message.

In some embodiments of the present application, the method may include: in response to receiving another configuration of the TAT-SDT, stopping the TAT-SDT, and starting another TAD-SDT as indicated by the other configuration of the TAT-SDT; or restarting the TAT-SDT as indicated by the other configuration of the TAT-SDT; or continuing running the TAT-SDT in the case of the TAT-SDT being ongoing.

Some embodiments of the present application provide a CU of a RAN node, including: a processor; and a transceiver coupled to the processor, wherein the processor is configured to: transmit an indication associated with SDT scheme selection for a UE from the CU to a DU; receive, by the CU from the DU, first CG-SDT resource configuration information for the UE in the case that CG-SDT is configured; and transmit, by the CU to the DU, a RRC release message for causing the UE to enter into a non-connected state with the first CG-SDT resource configuration information.

Some embodiments of the present application provide a DU of a RAN node, including: a processor; and a transceiver coupled to the processor, wherein the processor is configured to: receive an indication associated with SDT scheme selection for a UE from a CU by the DU; transmit, by the DU from the CU, first CG-SDT resource configuration information for the UE in the case that CG-SDT is configured; and receive, by the DU from the DU, a RRC release message for causing the UE to enter into a non-connected state with the first CG-SDT resource configuration information.

Some embodiments of the present application provide a UE, including: a processor; and a transceiver coupled to the processor, wherein the processor is configured to: receive by the UE from a network side, a RRC release message with first CG-SDT resource configuration information; enter into a non-connected state in response to receiving from the RRC release message; and release the first CG-SDT resource configuration information in response to one of the following: receiving another RRC release message; falling back to RA-SDT or non-SDT; receiving a network indication indicating releasing the first CG-SDT resource configuration information; and expiry of a TAT-SDT associated with the first CG-SDT resource configuration information.

Embodiments of the present application provide a method and apparatus for small data transmission, which can solve issues on CG-SDT, e.g., issues on how to configure, reconfigure and release CG-SDT resource configuration information over F1 interface etc. Accordingly, the present application can facilitate and improve the implementation of NR.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a wireless communication system according to some embodiments of the present application.

FIG. 2 illustrates a schematic diagram of an internal structure of a RAN node according to some embodiments of the present application according to some embodiments of the present application.

FIG. 3 is a flow chart illustrating an exemplary procedure of a method for small data transmission according to some embodiments of the present application.

FIG. 4 is a flow chart illustrating an exemplary procedure of a method for small data transmission according to some other embodiments of the present application.

FIG. 5 is a flow chart illustrating an exemplary procedure of a method for small data transmission according to some yet other embodiments of the present application.

FIG. 6 is a flow chart illustrating an exemplary procedure of a method for small data transmission according to some yet other embodiments of the present application.

FIG. 7 is a flow chart illustrating an exemplary procedure of a method for small data transmission according to some yet other embodiments of the present application.

FIG. 8 illustrates a block diagram of an apparatus for small data transmission according to some embodiments of the present application.

FIG. 9 illustrates a block diagram of an apparatus for small data transmission according to some other embodiments of the present application.

### DETAILED DESCRIPTION

The detailed descriptions of the appended drawings are intended as descriptions of preferred embodiments of the present application and are not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP long term evolution (LTE), and so on. It is contemplated that along with the developments of network architectures and new service scenarios, all embodiments in the present application are also applicable to similar technical problems. Moreover, the terminologies recited in the present application may change, which should not affect the principle of the present application.

FIG. 1 illustrates a schematic diagram of an exemplary wireless communication system 100 according to some embodiments of the present application.

As shown in FIG. 1, the wireless communication system 100 includes at least one BS 101 and at least one UE 102. In particular, the wireless communication system 100 includes one BS 101 and two terminal device 102 (e.g., a UE 102a and UE 102b) for illustrative purpose. Although a specific number of BSs and terminal devices are illustrated in FIG. 1 for simplicity, it is contemplated that the wireless communication system 100 may include more or less BSs and terminal devices in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may communicate with a core network (CN) node (not shown), e.g., a mobility management entity (MME) or a serving gateway (S-GW), a mobility management function (AMF) or a user plane function (UPF) etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a radio access network (RAN) node. Each BS may serve a number of UE(s) within a serving area, for example, a cell or a cell sector via a wireless communication link. Neighbor BSs may communicate with each other as necessary, e.g., during a handover procedure for a UE.

The terminal device 102, e.g., the UE 102a and UE 102b may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the terminal device may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the terminal device may include wearable devices, such as smart watches, fitness bands, optical head-mounted displays, or the like. Moreover, the terminal device may be referred to as a subscriber unit, a mobile, a mobile station, a user, a terminal, a mobile terminal, a wireless terminal, a fixed terminal, a subscriber station, a user terminal, or a device, or described using other terminology used in the art. Herein (through the specification), although “UE” is used exemplarily as a classical terminal device for illustrating the terminal device, it should be understood as any type terminal device.

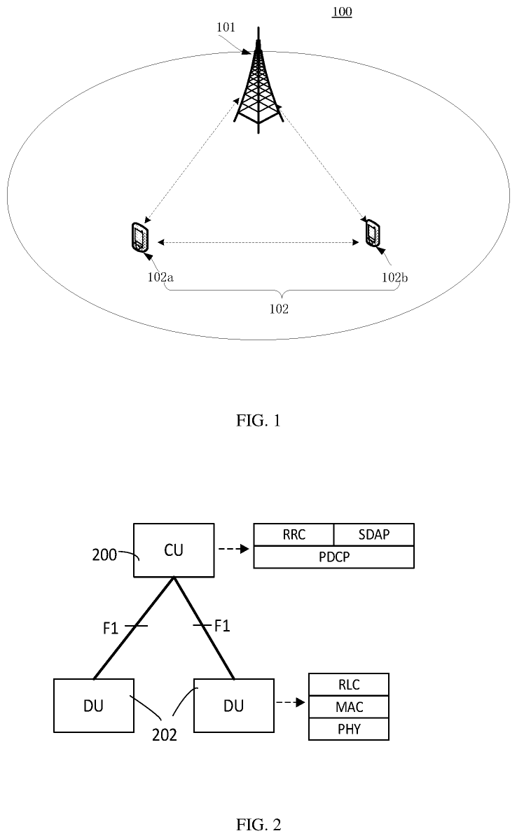

FIG. 2 is a schematic diagram illustrating an internal structure of a RAN node, e.g., a BS according to some embodiments of the present application.

Referring to FIG. 2, in a CU-DU split based RAN architecture, the internal structure of a RAN node (e.g., BS 101) may be split into a CU 200 and at least one DU 202 (e.g., two DUs shown in FIG. 2). Although a specific number of DUs 202 are depicted in FIG. 2, it is contemplated that any number of DUs 202 may be included in the BS.

The CU 200 and DU 202 are connected with each other by an interface called F1 as specified in 3GPP standard documents. The RRC layer functionality, service data adaptation protocol (SDAP) functionality, and the packet data convergence protocol (PDCP) layer functionality are located in the CU 200. The radio link control (RLC) layer functionality, medium access control (MAC) layer functionality, and the physical (PHY) layer functionality are located in the DU 202.

In LTE, in the case that a terminal device 102, e.g., a UE in a non-connected state wants to transmit data, it may trigger an early data transmission (EDT) procedure. The EDT procedure may include an EDT procedure for control plane (CP) cellular internet of things (CIoT) evolved packet system (EPS) optimizations and an EDT procedure for user plane (UP) CIOT EPS optimizations. In the EDT procedure for CP CIOT EPS optimizations, the data may be transmitted through a RRC early data request message. In the EDT procedure for UP CIOT EPS optimization, the data may be transmitted through an RRC connection resume request message.

The EDT procedure evolves into an SDT procedure in NR. According to a NR Rel-17 work item, there are two SDT schemes (or SDT types) for UE in RRC_INACTIVE state, i.e., RA-SDT and CG-SDT. In RAN2 #113e, it was agreed that UE may fall back to RA-SDT from CG-SDT. For example, in response to the arrival of data only for DRB(s) and/or signaling radio bearer (SRB) (s) for which SDT is enabled, a high level procedure for selection between SDT and non-SDT is as follows: if the criteria for CG-SDT is met, then UE selects CG-SDT and initiates a CG-SDT procedure; else, if the criteria for RA-SDT is met, then UE selects RA-SDT and initiates a RA-SDT procedure; and else, UE initiates a non-SDT procedure.

However, there are only a few agreements on CG-SDT. For example, regarding the CG-SDT configuration for UE, RAN2 agreed that CG-SDT resource configuration information is provided in a RRC release message, but has no agreement on whether and how the CU or DU in the CU-DU split based RAN architecture decides which SDT scheme should be configured during a RRC release procedure.

For another example, for CG-SDT, the DU needs to store the UE context, e.g., including the CG-SDT resource configuration information and maintain the UE associated logical F1 connection of the UE in RRC_INACTIVE state. During the SDT procedure, if the UE falls back to a RA-SDT procedure or non-SDT procedure from a CG-SDT procedure, a new UE associated logical F1 connection will be setup for the UE during the RA-SDT procedure or non-SDT procedure. When the SDT procedure ends, the network side may decide to reconfigure or release the CG-SDT resource configuration information for the UE. However, since a new (relative to the previous one) UE associated logical F1 connection was setup while the previous CG-SDT resource configuration information was linked to the previous UE associated logical F1 connection, the DU has no idea about the previous CG-SDT resource configuration information. Therefore, in the case that the UE falls back to the RA-SDT or non-SDT from the CG-SDT, how the CU and DU reconfigure or release the previous CG-SDT resource configuration information in the new UE associated logical F1 connection needs to be addressed.

For yet another example, RAN2 agreed that UE releases the CG-SDT resource configuration information when the associated TAT-SDT expires in RRC_INACTIVE state. The DU may also release the CG-SDT resource configuration information due to the TAT-SDT expiry. In this case, how to release the UE context, the UE associated logical F1 connection and use plane resource between the CU and DU also needs to be solved. The TAT-SDT is a SDT specific time align timer which is used to control how long the UE is considered uplink time aligned for the CG-SDT resource(s).

Given the above, embodiments of the present application provide technical solutions for small data transmission, especially for CG-SDT, e.g., how to configure CG-SDT resource configuration information, how to reconfigure CG-SDT resource configuration information and how to release CG-SDT resource configuration information etc.

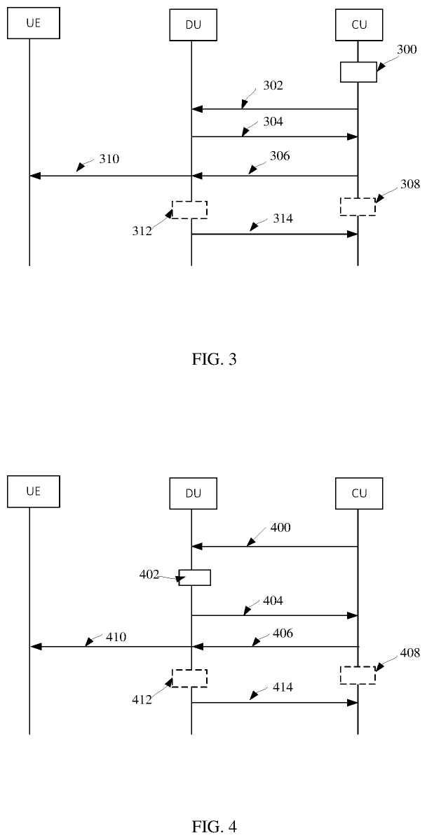

FIG. 3 is a flow chart illustrating an exemplary procedure of a method for small data transmission according to some embodiments of the present application. Although the method is illustrated in a system level by a UE in a remote side (or UE side), and a CU and DU of a RAN node in a network side (or BS side), persons skilled in the art can understand that the method implemented in the remote side and that implemented in the network side can be separately implemented and incorporated by other apparatus with the like functions. In some embodiments of the present application, the CU may be called as gNB-CU and DU may be called as gNB-DU. Hereafter the same.

As shown in FIG. 3, according to some embodiments of the present application, for a UE to enter into a non-connected state, the CU decides (or selects) which SDT scheme, e.g., CG-SDT or RA-SDT will be configured for the UE in step 300. Herein (through the specification), the non-connected state may be an active mode, e.g., RRC_INACTIVE state or RRC_IDLE state. The CU will transmit an indication associated with SDT scheme selection to the DU in step 302. In the case that the CU decides the CG-SDT will be configured for the UE, the indication associated with SDT scheme selection is a CG-SDT required indication indicating the DU that CG-SDT is required to be configured for the UE, or is a CG-SDT inquiry indication indicating the DU that CG-SDT is requested to be configured for the UE. For example, the CU will transmit a CG-SDT required indication or CG-SDT inquiry indication to the DU in a UE context modification request message. In some embodiments of the present application, the CG-SDT required indication or the CG-SDT inquiry indication is associated with a DRB, i.e., is per DRB.

Accordingly, the DU will receive the indication associated with SDT scheme selection for the UE, e.g., a CG-SDT required indication or CG-SDT inquiry indication in a UE context modification request message. In the case that the DU admits the CG-SDT, that is, CG-SDT will be configured by the DU, the DU will provide CG-SDT resource configuration information, e.g., first CG-SDT resource configuration information to the CU in step 304, e.g. in a UE context modification response message.

After receiving the first CG-SDT resource configuration information, the CU will transmit to the DU a RRC release message for causing the UE to enter into a non-connected state, e.g., RRC_INACTIVE state with the first CG-SDT resource configuration information in step 306. For example, the RRC release message with the first CG-SDT resource configuration information may be transmitted by the CU to the DU in a UE context release message, e.g., a UE Context Release Command. In some embodiments of the present application, the CU may also store the received CG-SDT resource configuration information for reconfiguration or other uses in step 308, which may be performed after transferring the RRC release message to the DU, or may be performed before or simultaneously with transferring the RRC release message to the DU. The DU will transfer the RRC release message with the first CG-SDT resource configuration information to the UE to send the UE to a non-connected state in step 310. In some embodiments of the present application, the DU may also store the CG-SDT resource configuration information of the UE, e.g., the first CG-SDT resource configuration information and C-RNTI associated with the UE for sequent CG-SDT in step 312 in response to receiving the UE context release message from the CU, which may be performed after transferring the RRC release message to the UE, or may be performed before or simultaneously with transferring the RRC release message to the UE. In some embodiments of the present application, in response to the UE context release message, the DU may also transmit a UE context release complete message to the CU in step 314 after transferring the RRC release message to the UE.

In some other embodiments of the present application, the DU rather than the CU will decide (or select) which SDT scheme, e.g., CG-SDT or RA-SDT will be configured for the UE.

FIG. 4 is a flow chart illustrating an exemplary procedure of a method for small data transmission according to some other embodiments of the present application. Similarly, although the method is illustrated in a system level by a UE in a remote side (or UE side), and a CU and DU of a RAN node in a network side (or BS side), persons skilled in the art can understand that the method implemented in the remote side and that implemented in the network side can be separately implemented and incorporated by other apparatus with the like functions.

As shown in FIG. 4, according to some embodiments of the present application, the CU will transmit an indication associated with SDT scheme selection to the DU, e.g., a gNB-DU in step 400. The indication associated with SDT scheme selection is an SDT indication indicating the DU whether a DRB or a QoS flow or a PDU session is subject to an SDT. For example, during a DRB setup procedure, the CU may indicate the DU whether a DRB or a QoS flow or a PDU session is subject to an SDT by an explicit indication or by an implicit QoS parameter, e.g., in a UE context modification request message.

Accordingly, the DU will receive the indication associated with SDT scheme selection for the UE. Based on the indication associated with SDT scheme selection for the UE, the DU will determine whether CG-SDT will be configured for the UE in step 402. In the case that the DU decides that CG-SDT will be configured, the DU will provide CG-SDT resource configuration information to the CU in step 404, e.g. first CG-SDT resource configuration information in a UE context modification response message.

After receiving the first CG-SDT resource configuration information, the CU will transmit to the DU a RRC release message for causing the UE to enter into a non-connected state, e.g., RRC_INACTIVE state with the first CG-SDT resource configuration information in step 406. For example, the RRC release message with the first CG-SDT resource configuration information may be transmitted by the CU to the DU in a UE context release message, e.g., a UE Context Release Command. In some embodiments of the present application, the CU may also store the received CG-SDT resource configuration information for reconfiguration or other uses in step 408, which may be performed after transferring the RRC release message to the DU, or may be performed before or simultaneously with transferring the RRC release message to the DU. The DU will transfer the RRC release message with the first CG-SDT resource configuration information to the UE to send the UE to a non-connected state in step 410. In some embodiments of the present application, the DU may also store the first CG-SDT resource configuration information and C-RNTI associated with the UE for sequent CG-SDT in step 412 in response to receiving the UE context release message from the CU, which may be performed after transferring the RRC release message to the UE, or may be performed before or simultaneously with transferring the RRC release message to the UE. In response to the UE context release message, the DU may also transmit a UE context release complete message to the CU in step 414 after transferring the RRC release message to the UE.

In some embodiments of the present application, the CG-SDT resource configuration information is pre-configured in the DU. The DU will apply the pre-configured CG-SDT resource configuration information when releasing the UE into a non-connected state, e.g., RRC-INACTIVE state in step 410.

According to some embodiments of the present application, although a UE is in a non-connected state, e.g., RRC_INACTIVE state, data may be generated in the UE and to be transmitted to the network side. Accordingly, the UE will trigger an SDT procedure to transmit the generated data, which may be a RA-SDT or CG-SDT. In some other embodiments of the present application, a non-SDT procedure may be triggered to transmit the generated data.

The UE may perform an SDT scheme selection procedure as follows: if a CG-SDT criteria is met, the UE will select the CG-SDT and will initiate a CG-SDT procedure; and else, if a RA-SDT criteria is met, the UE will select the RA-SDT and will initiate a RA-SDT procedure. If the RA-SDT criteria is not met either, the UE will initiate a non-SDT procedure. Wherein the CG-SDT criteria will be considered met, if all of the following conditions are met: 1) an available data volume is not larger than a data volume threshold; 2) reference signal received power (RSRP) is greater than or equal to a configured threshold; and 3) CG-SDT resources are configured on the selected UL carrier and are valid. In addition, the RA-SDT criteria will be considered met, if all of the following conditions are met: 1) an available data volume is not larger than a data volume threshold; 2) RSRP is greater than or equal to a configured threshold; and 3) 4 step RA-SDT resources are configured on the selected UL carrier and the criteria for selecting 4 step RA-SDT is met; or 2 step RA-SDT resources are configured on the selected UL carrier and the criteria for selecting 2 step RA-SDT is met.

Thus, for a UE with CG-SDT configuration, it may fall back to RA-SDT or non-SDT from CG-SDT according to the SDT scheme selection procedure in the case that the CG-SDT criteria is not met.

As stated above, in some embodiments of the present application, the CU stores the CG-SDT resource configuration information. In the case that the UE falls back to RA-SDT or non-SDT from CG-SDT, the CU will send the stored CG-SDT resource configuration information to the DU for reconfiguration of CG-SDT resource configuration information.

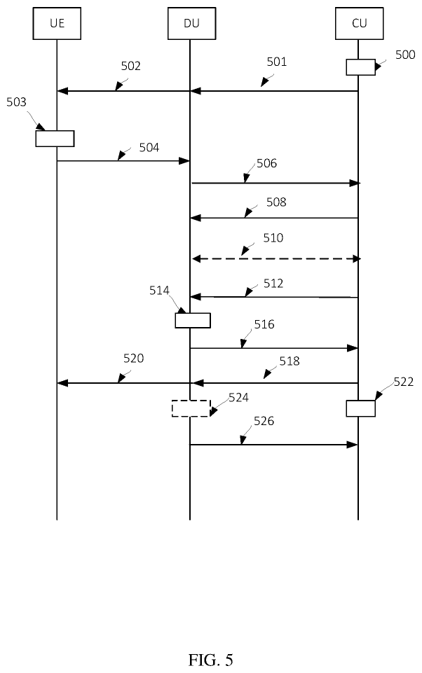

FIG. 5 is a flow chart illustrating an exemplary procedure of a method for small data transmission according to some yet other embodiments of the present application. Although the method is illustrated in a system level by a UE in a remote side (or UE side), and a CU and DU of a RAN node, e.g., a BS in a network side (or BS side), persons skilled in the art can understand that the method implemented in the remote side and that implemented in the network side can be separately implemented and incorporated by other apparatus with the like functions.

As shown in FIG. 5, in step 500, the CU, e.g., a gNB-CU will store CG-SDT resource configuration information, e.g., the first CG-SDT resource configuration information for a UE in step 500, which will be sent to a non-connected state, e.g., RRC_INACTIVE state. The first CG-SDT resource configuration information can be provided according to embodiments shown in FIG. 3 or FIG. 4 or other manners, and thus will not be repeated. The CU will transmit to the DU a RRC release message for causing the UE to enter into the non-connected state with the first CG-SDT resource configuration information in step 501. Then, the DU will transfer the RRC release message with the first CG-SDT resource configuration information to the UE to send the UE to a non-connected state in step 502. The UE will receive the first CG-SDT resource configuration information with the RRC release message transferred by the DU and then enter into a non-connected state in response to the RRC release message.

In the case that the UE in the non-connected state has data to be transmitted while the CG-SDT criteria is not met, it may fall back to RA-SDT in step 503. In step 504, the UE will trigger a RA-SDT procedure and transmit a RRC resume request message with the data to be transmitted to the DU. After receiving the data and the RRC resume request message, the DU will transmit an indication of RA-SDT, which indicates that RA-SDT is performed by the UE to the CU in step 506, e.g., in a non-UE associated INITIAL UL RRC MESSAGE TRANSFER message. The indication of RA-SDT may be a cause value in some embodiments of the present application, so that the CU knows that the RRC resume request message is caused by the RA-SDT and the UE falls back to RA-SDT from CG-SDT. The CU will allocate a CU UE F1AP ID and send a UE context setup request message to the DU in step 508, which includes the UE context for the RA-SDT. Accordingly, during the RA-SDT procedure, a new (relative to the previous one) C-RNTI will be allocated by the DU, and a new UE context and UE associated logic F1 connection will be established between the CU and the DU. In the case that the CU identifies that a new UE associated logic F1 connection has been setup e.g. according to the UE identity (e.g., I-RNTI) in the RRC resume request message, the CU will trigger a UE context release procedure to release the previous (or old) UE associated logic F1 connection in step 510. The DU will release the stored previous UE context including the previous CG-SDT resource configuration information, e.g., the first CG-SDT resource configuration information.

The CU may decide that after the RA-SDT procedure, the UE may be sent to a non-connected state again. In some embodiments of the present application, the CU may determine that the CG-SDT will be configured for the UE, which is similar to that illustrated in FIG. 3. In some other embodiments of the present application, whether the CG-SDT will be configured for the UE may be decided by the DU, which is similar to that illustrated in FIG. 4, and the CU will indicate the DU whether a DRB or a QoS flow or a PDU session is subject to an SDT by an explicit indication or by an implicit QoS parameter. The CU will transmit the stored (old) CG-SDT resource configuration information, e.g., the first CG-SDT resource configuration information to the DU in step 512, so that CG-SDT resource configuration information is to be reconfigured for the UE based on the first CG-SDT resource configuration information after the RA-SDT. The first CG-SDT resource configuration information may be a RRC container included in the CU to DU RRC container IE. In some other embodiments of the present application, the first CG-SDT resource configuration information may be included in a UE context modification request message. The CU may also provide the radio link measurement information, e.g., RSRP to the DU so that the DU selects CG-SDT resources based on the radio link measurement information.

After receiving the stored (previous or old) CG-SDT resource configuration information, the DU will determine whether to update (or reconfigure) the CG-SDT resource configuration information. In step 514, in the case that the DU determines to reconfigure the CG-SDT resource configuration information, the DU will generate new CG-SDT resource configuration information, e.g., the second CG-SDT resource configuration information based on the previous CG-SDT resource configuration information. The new CG-SDT resource configuration information may be delta configuration information of the previous CG-SDT resource configuration information or full CG-SDT resource configuration information. The DU will transmit the new CG-SDT resource configuration information to the CU in step 516. For example, the new CG-SDT resource configuration information may be a RRC container included in the DU to CU RRC container IE. In another example, the new CG-SDT resource configuration information may be included in a UE context modification response message.

After receiving the new CG-SDT resource configuration information, e.g., the second CG-SDT resource configuration information, the CU will transmit to the DU a RRC release message for causing the UE to enter into a non-connected state, e.g., RRC_INACTIVE state with the second CG-SDT resource configuration information in step 518. The DU will transfer the RRC release message with the second CG-SDT resource configuration information to the UE in step 520. Similarly, the CU also stores the second CG-SDT resource configuration information in step 522 to further support reconfiguration of CG-SDT resource configuration information. The old CG-SDT resource configuration information will be replaced with the new CG-SDT resource configuration information in the CU, e.g., the first CG-SDT resource configuration information will be replaced with the second CG-SDT resource configuration information. The RRC release message with the second CG-SDT resource configuration information may be transmitted by the CU to the DU in a UE context release message, e.g., a UE Context Release Command. In some embodiments of the present application, in step 524, the DU may also store the second CG-SDT resource configuration information of the UE and C-RNTI associated with the UE for sequent CG-SDT in response to receiving the UE context release message from the CU. In response to the UE context release message, the DU may also transmit a UE context release complete message to the CU in step 526 after transferring the RRC release message to the UE.

In some embodiments of the present application, the CU will not store the CG-SDT resource configuration information, or even if stored the CG-SDT resource configuration information, the CU will not transmit the stored CG-SDT resource configuration information to the DU for reconfiguration. In the case that the UE falls back to RA-SDT or non-SDT from CG-SDT, the CU will send the ID of the old (or previous) CG-SDT resource configuration information, e.g., the first CG-SDT resource configuration information so that the DU can retrieve the old CG-SDT resource configuration information for reconfiguration of CG-SDT resource configuration information for the UE.

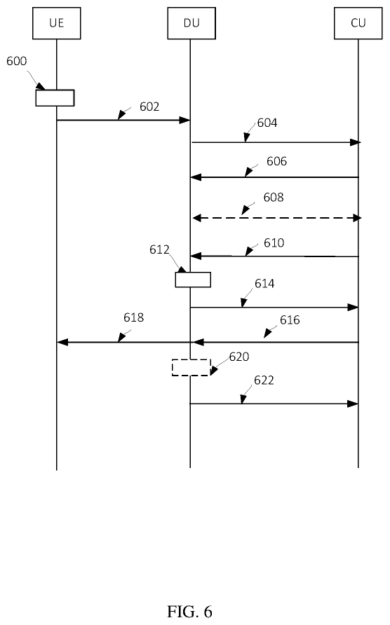

FIG. 6 is a flow chart illustrating an exemplary procedure of a method for small data transmission according to some yet other embodiments of the present application. Although the method is illustrated in a system level by a UE in a remote side (or UE side), and a CU and DU of a RAN node, e.g., a BS in a network side (or BS side), persons skilled in the art can understand that the method implemented in the remote side and that implemented in the network side can be separately implemented and incorporated by other apparatus with the like functions.

As shown in FIG. 6, in the case that the UE in the non-connected state, e.g., in RRC_INACTIVE state has data to be transmitted and the CG-SDT criteria is not met, it may fall back to RA-SDT in step 600. In step 602, the UE will trigger a RA-SDT procedure and transmit a RRC resume message with the data to be transmitted to the DU. After receiving the data and the RRC resume request message, the DU will transmit an indication of RA-SDT to the CU in step 604, which indicates that RA-SDT is performed by the UE, e.g., in a non-UE associated INITIAL UL RRC MESSAGE TRANSFER message. The indication of RA-SDT may be a cause value in some embodiments of the present application, so that the CU knows that the RRC resume request message is caused by RA-SDT and the UE falls back to RA-SDT from CG-SDT. The CU will allocate a CU UE F1AP ID and send a UE context setup request message to the DU in 606, which includes the UE context for the RA-SDT. Accordingly, during the RA-SDT procedure, a new C-RNTI will be allocated by the DU, and a new UE context and UE associated logic F1 connection will be established between the CU and the DU. In the case that the CU identifies that a new UE associated logic F1 connection has been setup, e.g. according to the UE identity (e.g., I-RNTI) in the RRC resume request message, the CU will trigger a UE context release procedure to release the previous (or old) UE associated logic F1 connection in step 608. The DU will release the stored previous UE context including the previous CG-SDT resource configuration information, e.g., the first CG-SDT resource configuration information.

The CU may decide that after the RA-SDT procedure, the UE may be sent to a non-connected state again. In some embodiments of the present application, the CU may determine that the CG-SDT will be configured for the UE, which is similar to that illustrated in FIG. 3. In some other embodiments of the present application, whether the CG-SDT will be configured for the UE may be decided by the DU, which is similar to that illustrated in FIG. 4, and the CU will indicate the DU whether a DRB or a QoS flow or a PDU session is subject to an SDT by an explicit indication or by an implicit QoS parameter. The CU will transmit the ID of the old CG-SDT resource configuration information e.g., the first CG-SDT resource configuration information to the DU in step 610, so that CG-SDT resource configuration information will be reconfigured for the UE based on the first CG-SDT resource configuration information after the RA-SDT. The ID of the old CG-SDT resource configuration information is used to uniquely identify the old UE associated F1 connection for the UE within a DU, which may be the old C-RNTI or the old DU UE F1AP ID associated with the UE. The stored ID of the old CG-SDT resource configuration information may be included in the UE CONTEXT MODIFICATION REQUEST message. The CU may also provide the radio link measurement information, e.g., RSRP to the DU so that the DU selects CG-SDT resources based on the radio link measurement information.

After receiving the ID of the old CG-SDT resource configuration information, e.g., the first CG-SDT resource configuration information, the DU will retrieval the old RRC CG-SDT resource configuration information and determine whether to update (or reconfigure) the CG-SDT resource configuration information. In step 612, in the case that the DU determines to reconfigure the CG-SDT resource configuration information, the DU will generate a new CG-SDT resource configuration information e.g., second CG-SDT resource configuration information based on the previous CG-SDT resource configuration information. The new CG-SDT resource configuration information may be delta configuration information of the previous CG-SDT resource configuration information or a full CG-SDT resource configuration. The DU will transmit the new CG-SDT resource configuration information to the CU in step 614. For example, the new CG-SDT resource configuration information may be a RRC container included in the DU to CU RRC container IE. In another example, the new CG-SDT resource configuration information may be included in a UE context modification response message.

After receiving the new CG-SDT resource configuration information, e.g., the second CG-SDT resource configuration information, the CU will transmit to the DU a RRC release message for causing the UE to enter into a non-connected state, e.g., RRC_INACTIVE state with the second CG-SDT resource configuration information in step 616. For example, the RRC release message with the second CG-SDT resource configuration information may be transmitted in a UE context release message. The DU will transfer the RRC release message with the second CG-SDT resource configuration information to the UE in step 618. Similarly, in some embodiments of the present application, in step 620, the DU may also store the second CG-SDT resource configuration information and C-RNTI associated with the UE for sequent CG-SDT in response to receiving the UE context release message from the CU. In response to the UE context release message, the DU may also transmit a UE context release complete message to the CU in step 622 after transferring the RRC release message to the UE.

Embodiments of the present application also provide technical solutions on how to release UE context and the UE-associated logical F1 connection, e.g., CG-SDT resource configuration information etc.

According to some embodiments of the present application, the DU, e.g., a gNB-DU will send a TAT-SDT to the CU, e.g., a gNB-CU. The TAT-SDT is a time alignment timer, which is used to control how long the UE is considered uplink time aligned for the CG-SDT resource(s). In the case that the TAT-SDT expires, both the DU and CU will release the stored F1-connection and related CG-SDT resource configuration information associated with the TAT-SDT locally. That is, the releasing of CG-SDT configuration in the CU, DU and UE are separately.

FIG. 7 is a flow chart illustrating an exemplary procedure of a method for small data transmission according to some yet other embodiments of the present application. Although the method is illustrated in a system level by a UE in a remote side (or UE side), and a CU and DU of a RAN node, e.g., a BS in a network side (or BS side), persons skilled in the art can understand that the method implemented in the remote side and that implemented in the network side can be separately implemented and incorporated by other apparatus with the like functions.

As shown in FIG. 7, in step 700, the DU may transmit a TAT-SDT, e.g., a first TAT-SDT to the CU. In some embodiments of the present application, the TAT-SDT may be included in the CG-SDT resource configuration information, e.g., the first CG-SDT resource configuration information. For example, when the DU generates CG-SDT resource configuration information, e.g., the first CG-SDT resource configuration information which includes a TAT-SDT, the DU will send the TAT-SDT to the CU in a F1AP message, e.g., in a UE context modification response message. In the case that the TAT-SDT has been started when releasing the UE into a non-connected state, e.g., RRC_INACTIVE state, the DU may send the remaining value of the TAT-SDT to the CU. In some embodiments of the present application, the TAT-SDT is included in a F1AP message, while is outside of the CG-SDT resource configuration information.

In step 702, the DU will start the TAT-SDT in response to the TAT-SDT being configured or sending a RRC release message to the UE.

In step 704, the CU will start the TAT-SDT in response to triggering a UE context release procedure, e.g., sending the UE into RRC_INACTIVE state or in response to receiving the TAD-SDT, or response to sending a RRC release message for the UE. The CU will stop the TAT-SDT in response to receiving small data or receiving a RRC resume request message.

In the case that the TAT-SDT expires, the DU and CU will release the UE associated logic F1 connection and related UE context, e.g. CG-SDT resource configuration information locally. For example, in the case that the TA-SDT expires in the DU, the DU will release the UE associated logic F1 connection and related UE context in step 706. In the case that the TA-SDT expires in the CU, the CU will release the UE associated logic F1 connection and related UE context in step 708.

In the case that the UE receives a new configuration of TAT-SDT in a RRC release message in step 710, the UE may stop the ongoing TAT-SDT, e.g., a the first TAT-SDT and start a new TAT-SDT, e.g., a second TAT-SDT as indicated in the new configuration of TAT-SDT. In some other embodiments of the present application, the UE may restart the TAT-SDT as indicated in the new configuration of TAT-SDT. In some yet other embodiments of the present application, the UE may continue to run the ongoing TAT-SDT if it is running. When the TAT-SDT expires according to the value indicated in the TAT-SDT configuration, the UE will release the CG-SDT resource configuration information in step 712, e.g., the first CG-SDT resource configuration information.

According to some other embodiments of the present application, the DU will request the CU to release the UE context and UE-associated logical F1 connection etc., in response to the TAT-SDT expiring, that is, releasing the first CG-SDT resource configuration information is not local in DU and CU. For example, the DU may start the TAT-SDT, e.g., the first TAT-SDT in response to the TAT-SDT being configured or upon sending a RRC release message to the UE. In the case that the TAT-SDT expires in the DU, the DU will trigger a UE context release request procedure to request the CU to release the UE-associated logical F1 connection etc. For example, the DU will send a UE context release request message to the CU, wherein a cause value, e.g., “TAT-SDT expiry” is included to indicate the CU that the RRC release request is caused by the TAT-SDT expiry. Then, the CU will release the UE-associated logical F1 connection etc.

Regarding releasing the CG-SDT resource configuration information in the UE, there are several manners besides the expiry of a TAT-SDT associated with the CG-SDT resource configuration information as illustrated above. For example, the UE may receive from a network side, e.g., a gNB-DU, a RRC release message with CG-SDT resource configuration information, e.g., the first CG-SDT resource configuration information and then enter into a non-connected state in response to receiving the RRC release message. The UE will release the first CG-SDT resource configuration information in response to receiving another RRC release message, i.e., a new (or next) RRC release message. In some other embodiments of the present application, the UE will release the first CG-SDT resource configuration information in response to falling back to RA-SDT or non-SDT from CG-SDT. In some other embodiments of the present application, the UE will release the first CG-SDT resource configuration information in response to receiving a network indication indicating releasing the first CG-SDT resource configuration information. The network indication may indicate releasing the first CG-SDT resource configuration information by including full CG-SDT resource configuration information in the new RRC release message. According to some embodiments of the present application, the UE may release the previous CG-SDT resource configuration information and apply new CG-SDT resource configuration information if any in response to receiving the RRC release message, e.g., releasing the first CG-SDT resource configuration information and apply the second CG-SDT resource configuration information.

Persons skilled in the art should understand that the technical solutions regarding configuring, reconfiguring and releasing CG-SDT resource configuration information disclosed in the present application can be separately implemented and also can be incorporated with each other. For example, configuration embodiments illustrated in FIG. 3 can be incorporated with reconfiguration embodiments illustrated in FIG. 5 or FIG. 6, and/or can also be incorporated with release embodiments illustrated in FIG. 7 or other release embodiments illustrated in the present application. Configuration embodiments illustrated in FIG. 4 can also be incorporated with reconfiguration embodiments illustrated in FIG. 5 or FIG. 6, and/or can also be incorporated with release embodiments illustrated in FIG. 7 or other release embodiments illustrated in the present application.

In addition, although the steps illustrated in sequence, persons skilled in the art should understand that that is only for clear description. Unless the implementation of a step dependent on a previous step, the description sequence or step number should not be deemed as the sequence limitation among the steps. The wording “first,” “second,” “new,” and “old” etc. are only used for distinguishing to achieve clear description, and should not be deemed as the limitation.

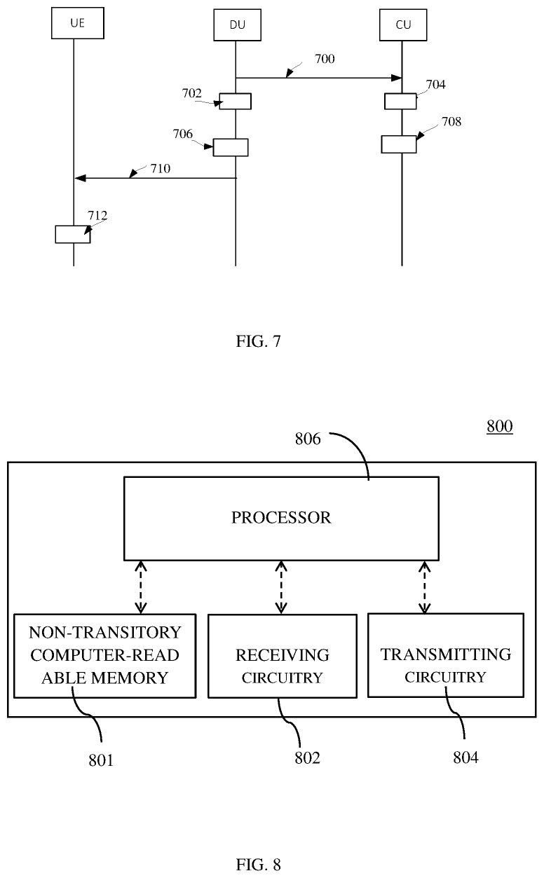

Besides methods, embodiments of the present application also propose an apparatus for small data transmission. For example, FIG. 8 illustrates a block diagram of an apparatus 800 for small data transmission according to some embodiments of the present application.

As shown in FIG. 8, the apparatus 800 may include at least one non-transitory computer-readable medium 801, at least one receiving circuitry 802, at least one transmitting circuitry 804, and at least one processor 806 coupled to the non-transitory computer-readable medium 801, the receiving circuitry 802 and the transmitting circuitry 804. The apparatus 800 may be a terminal device (e.g., a UE) configured to perform a method illustrated in the above or the like.

Although in this figure, elements such as the at least one processor 806, transmitting circuitry 804, and receiving circuitry 802 are described in the singular, the plural is contemplated unless a limitation to the singular is explicitly stated. In some embodiments of the present application, the receiving circuitry 802 and the transmitting circuitry 804 can be combined into a single device, such as a transceiver. In certain embodiments of the present application, the apparatus 800 may further include an input device, a memory, and/or other components.

In some embodiments of the present application, the non-transitory computer-readable medium 801 may have stored thereon computer-executable instructions to cause a processor to implement the method with respect to the terminal device as described above. For example, the computer-executable instructions, when executed, cause the processor 806 interacting with receiving circuitry 802 and transmitting circuitry 804, so as to perform the steps with respect to the UE as depicted above.

In some embodiments of the present application, the non-transitory computer-readable medium 801 may have stored thereon computer-executable instructions to cause a processor to implement the method with respect to the CU or DU as described above. For example, the computer-executable instructions, when executed, cause the processor 806 interacting with receiving circuitry 802 and transmitting circuitry 804, so as to perform the steps with respect to the CU or DU illustrated above.

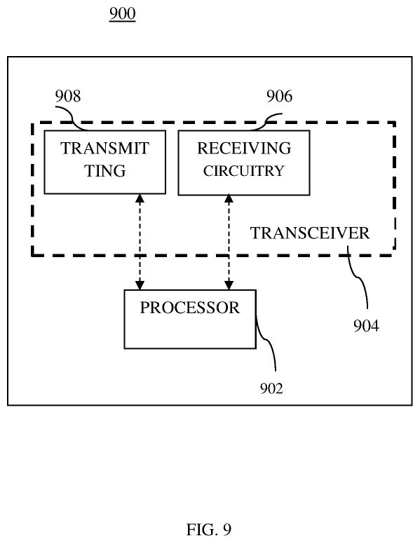

FIG. 9 is a block diagram of an apparatus for small data transmission according to some other embodiments of the present application.

Referring to FIG. 9, the apparatus 900, for example a UE, a RAN node, a CU or a DU of a RAN node, and may include at least one processor 902 and at least one transceiver 904. The transceiver 904 may include at least one separate receiving circuitry 906 and transmitting circuitry 908, or at least one integrated receiving circuitry 906 and transmitting circuitry 908.

According to some embodiments of the present application, when the apparatus 900 is a UE, the processor is configured to: receive, by the UE from a network side, a RRC release message with CG-SDT resource configuration information, e.g., first CG-SDT resource configuration information; enter into a non-connected state in response to receiving from the RRC release message; and release the first CG-SDT resource configuration information in response to one of the following: receiving another RRC release message; falling back to RA-SDT or non-SDT; receiving a network indication indicating releasing the first CG-SDT resource configuration information; and expiry of a TAT-SDT associated with the first CG-SDT resource configuration information.

According to some other embodiments of the present application, when the apparatus 900 is a CU of a RAN node, the processor may be configured to: transmit an indication associated with SDT scheme selection for a UE from the CU to a DU; receive, by the CU from the DU, CG-SDT resource configuration information, e.g., first CG-SDT resource configuration information for the UE in the case that CG-SDT is configured; and transmit, by the CU to the DU, a RRC release message for causing the UE to enter into a non-connected state with the first CG-SDT resource configuration information.

According to some yet other embodiments of the present application, when the apparatus 900 is a DU of a RAN node, the processor may be configured to: receive an indication associated with SDT scheme selection for a UE from a CU by the DU; transmit, by the DU from the CU, CG-SDT resource configuration information, e.g., first CG-SDT resource configuration information for the UE in the case that CG-SDT is configured; and receive, by the DU from the DU, a RRC release message for causing the UE to enter into a non-connected state with the first CG-SDT resource configuration information.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus including a processor and a memory. Computer programmable instructions for implementing a method stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. An apparatus for performing a network function, the apparatus comprising:
at least one memory; and
at least one processor coupled with the at least one memory and configured to cause the apparatus to:
transmit an indication associated with small data transmission (SDT) scheme selection for a user equipment (UE) from a central unit (CU) to a distributed unit (DU);
receive, by the CU from the DU, first configured grant (CG)-SDT resource configuration information for the UE in response to CG-SDT being configured; and
transmit, by the CU to the DU, a radio resource control (RRC) release message for causing the UE to enter into a non-connected state with the first CG-SDT resource configuration information.

2. The apparatus of claim 1, wherein the indication associated with SDT scheme selection is a CG-SDT required indication or a CG-SDT inquiry indication in response to the CU determining that CG-SDT is to be configured for the UE.

3. The apparatus of claim 1, wherein the indication associated with SDT scheme selection is an SDT indication indicating the DU whether a data radio bearer (DRB) or a quality of service (QOS) flow or a protocol data unit (PDU) session is subject to an SDT.

4. The apparatus of claim 1, wherein the at least one processor is configured to cause the apparatus to:
store, by the CU, the first CG-SDT resource configuration information received from the DU;
receive, by the CU from the DU, an indication of random access (RA)-SDT which indicates that RA-SDT is performed by the UE which has entered into the non-connected state caused by the RRC release message; and
transmit, by the CU to the DU, the first CG-SDT resource configuration information so that CG-SDT resource configuration information is to be reconfigured for the UE based on the first CG-SDT resource configuration information after the RA-SDT.

5. The apparatus of claim 1, wherein the at least one processor is configured to cause the apparatus to:
receive, by the CU from the DU, an indication of random access (RA)-SDT which indicates that RA-SDT is performed by the UE which has entered into the non-connected state caused by the RRC release message; and
transmit, by the CU to the DU, an identity of the first CG-SDT resource configuration information so that CG-SDT resource configuration information is to be reconfigured for the UE based on the first CG-SDT resource configuration information after the RA-SDT.

6. The apparatus of claim 1, wherein the at least one processor is configured to cause the apparatus to:
receive, by the CU from the DU, a time alignment timer (TAT)-SDT;
start, by the CU, the TAT-SDT in response to triggering a UE context release procedure; and
stop, by the CU, the TAT-SDT in response to receiving small data or receiving a resume request message.

7. The apparatus of claim 6, wherein the at least one processor is configured to cause the apparatus to release, by the CU, logic F1 connection associated with the UE and related UE context in response to expiry of the TAT-SDT.

8. The apparatus of claim 1, wherein the at least one processor is configured to cause the apparatus to release, by the CU from the DU, a UE context release request message for requesting the CU to release logic F1 connection associated with the UE, wherein the UE context release request message comprises a cause value indicating that the UE context release request message is caused by expiry of a time alignment timer (TAT)-SDT.

9. An apparatus for performing a network function, the apparatus comprising:
at least one memory; and
at least one processor coupled with the at least one memory and configured to cause the apparatus to:
receive an indication associated with small data transmission (SDT) scheme selection for a user equipment (UE) from a central unit (CU) by a distributed unit (DU);
transmit, by the DU to the CU, first configured grant (CG)-SDT resource configuration information for the UE in response to CG-SDT being configured; and
receive, by the DU from the CU, a radio resource control (RRC) release message for causing the UE to enter into a non-connected state with the first CG-SDT resource configuration information.

10. The apparatus of claim 9, wherein the indication associated with SDT scheme selection is a CG-SDT required indication or a CG-SDT inquiry indication indicating the DU that CG-SDT is required or requested to be configured for the UE.

11. The apparatus of claim 9, wherein the indication associated with SDT scheme selection is an SDT indication indicating the DU whether a data radio bearer (DRB) or a quality of service (QOS) flow or a protocol data unit (PDU) session is subject to an SDT, and the at least one processor is configured to cause the apparatus to determine whether CG-SDT is to be configured by the DU.

12. (canceled)

13. (canceled)

14. (canceled)

15. A user equipment (UE), comprising:
at least one memory; and
at least one processor coupled with the at least one memory and configured to cause the UE to:
receive, by the UE from a network side, a radio resource control (RRC) release message with first configured grant (CG)-SDT resource configuration information;
enter into a non-connected state in response to receiving from the RRC release message; and
release the first CG-SDT resource configuration information in response to one of the following:
receiving another RRC release message;
falling back to random access (RA)-SDT or non-SDT;
receiving a network indication indicating releasing the first CG-SDT resource configuration information; and
expiry of a time alignment timer (TAT)-SDT associated with the first CG-SDT resource configuration information.

16. A processor for wireless communication, comprising:
at least one controller coupled with at least one memory and configured to cause the processor to:
receive, by the processor from a network side, a radio resource control (RRC) release message with first configured grant (CG)-SDT resource configuration information;
enter into a non-connected state in response to receiving from the RRC release message; and
release the first CG-SDT resource configuration information in response to one of the following:
receiving another RRC release message;
falling back to random access (RA)-SDT or non-SDT;
receiving a network indication indicating releasing the first CG-SDT resource configuration information; and
expiry of a time alignment timer (TAT)-SDT associated with the first CG-SDT resource configuration information.
